(19) United States
(12) Patent Application Publication
(10) Pub. No.: US 2012/0059773 A1
(43) Pub. Date: Mar. 8, 2012

(54) SYSTEM FOR CALCULATING THE COST-PER-PAGE

(76) Inventors: Jerry Richard Jones, Indianapolis, IN (US); James Richard Fall, Indianapolis, IN (US); Kenneth Ross Howe, Greenwood, IN (US)

(21) Appl. No.: 12/978,439

(22) Filed: Dec. 24, 2010

Related U.S. Application Data
(60) Provisional application No. 61/380,037, filed on Sep. 3, 2010.

(51) Int. Cl. G06F 17/00

(52) U.S. Cl. 705/400

(57) ABSTRACT

A computer structured to calculate a cost-per-page for a fleet of printing devices. The computer is further structured to communicate with a device to output the cost-per-page to an operator.

### CROSS REFERENCE TO RELATED APPLICATIONS

The present application claims the benefit of U.S. Provisional Patent Application No. 61/380,037, filed Sep. 3, 2010, and the same is incorporated herein by reference in its entirety.

### BACKGROUND

The present application relates to a system for cost analysis, and more particularly, but not exclusively, relates to systems for analyzing the costs of a fleet of imaging and printing devices—printers, faxes, scanners multifunction devices, and/or copiers.

In a prior art system that calculated a cost-per-page (CPP), three different pricing models or pieces of software were needed. For example, a fleet of printing devices at a customer site may have been sorted into various categories. A first category may be a legacy category which includes monochrome non-multifunction printers and/or copiers and other printers commonly found in a person's office desk. A second category may be a black and white multifunction printer and/or copier. A third category may be for color multifunction printers and/or copiers. After a page study has been conducted, in which the average number of pages printed per year per device is calculated, the page study information would be inputted into one of the three models in three separate software programs. Generally, a CPP is the total cost for a number of devices in a year divided by the number of pages printed by those devices in the year. Various CPP calculations would be computed for each of the three categories. The calculated CPP would take in account, among other things, toner pricing, drum pricing, developer pricing, and the cost for labor and maintenance.

For printers that print in color, such as some in the legacy category or the color multifunction printer category, the price of toner would be distributed based on the percentage of color pages printed compared to the black and white pages printed. However, for other parts such as the cost of maintenance parts, drums and developer units, pricing was simply split 50/50 with respect to color and black and white pages. By not appropriating the cost of these parts based on the percentage of color pages printed to black and white pages printed, a true analysis of the cost to maintain a printing device cannot be determined.

A prior art system was also limited in the types and pricing for toners, drums, and developer units that could be inputted into a pricing model. Since three separate models or software programs had to be utilized to calculate various CPPs, a user would have to manually calculate an overall CPP based on the various software models. Moreover, a prior art system did not provide for any relationships between the three models when calculating a CPP.

There remains a need for more efficient and more precise ways to analyze the cost and design of a fleet of printers and/or copiers. Accordingly, further contributions are needed in this area of technology.

### SUMMARY

One embodiment of the present application is directed to a unique cost analysis system. Other embodiments include unique methods, systems, devices, and apparatus to analyze the cost of printers and/or copiers. Further embodiments, forms, features, aspects, benefits, and advantages of the present application shall become apparent from the description and figures provided herewith.

### BRIEF DESCRIPTION OF THE DRAWINGS

The description herein makes reference to the accompanying drawings wherein like reference numerals refer to like parts throughout the several views, and wherein:

FIG. 1 is a schematic diagram of a system for providing a cost-per-page (CPP) for a fleet of printers to a customer;

FIG. 2 is a schematic diagram of a computer system for providing a cost-per-page to a customer;

FIG. 3 is a schematic block diagram of a computer system for providing a cost-per-page to a customer;

FIG. 4 is a schematic flow diagram of a procedure for conducting a page study and data processing;

FIG. 5 is a schematic flow diagram of a procedure for processing Legacy printer information;

FIG. 6 is a schematic flow diagram of a procedure for processing B/W MFP information;

FIG. 7 is a schematic flow diagram of a procedure for processing Color MFP and Color Printer information;

FIG. 8 is a schematic flow diagram of a procedure for calculating CPPs; and

FIG. 9 is a schematic block diagram of a computer system for adjusting a CPP.

### DETAILED DESCRIPTION OF REPRESENTATIVE EMBODIMENTS

For purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

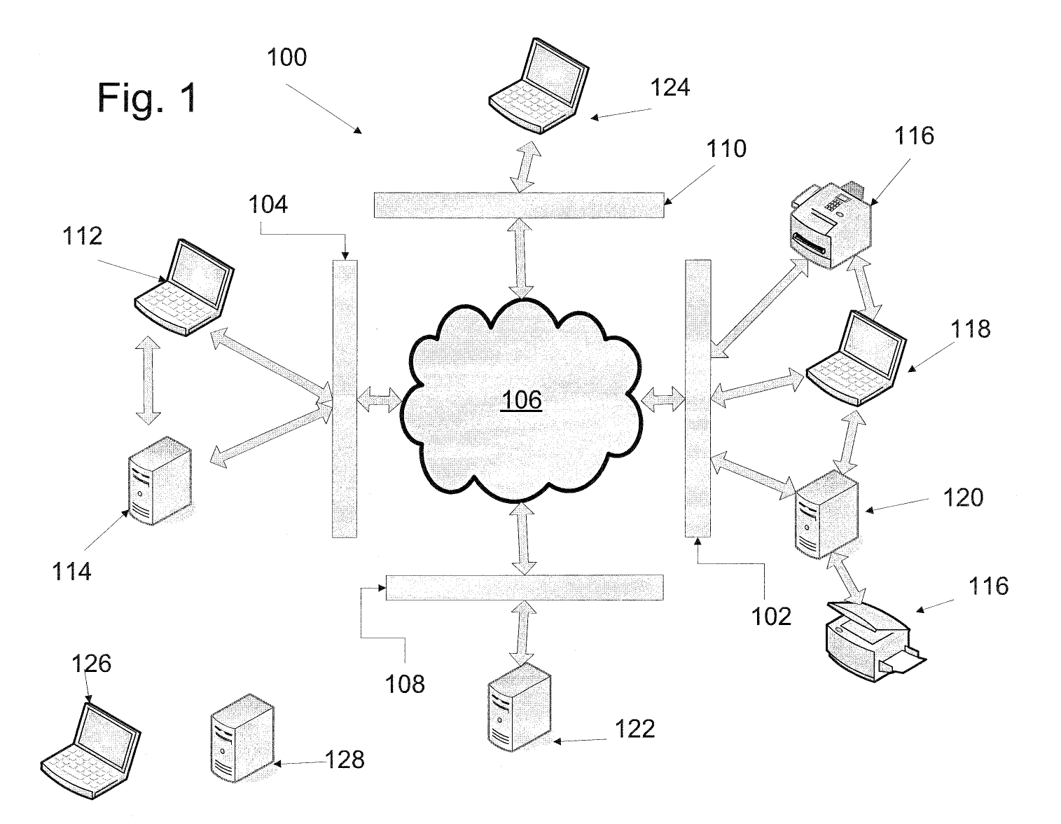

FIG. 1 is a schematic diagram of a system 100 for providing a Cost-Per-Page (CPP) to a customer. The system 100 includes a customer-side network 102 in communication with a CPP provider network 104 over a wide area network (WAN) 106 such as the Internet. The system 100 may further include a third party hosting network 108 and/or an individual network 110.

The system 100 further includes a computer 112 and a storage system 114 on the CPP provider network 104. The customer network 102 includes one or more printers and/or copiers 116, that may be part of a fleet of printers for a company, for example. The customer side network 102 may also include a computer 118 and a storage system 120.

The printers and/or copiers 116 on the customer network 102 may be any type of printing or copying device. Moreover, the printers and/or copiers may be categorized based on type. For example, a first category may be a Legacy category which includes monochrome non-multifunction printers and/or copiers and other printers commonly assigned to a small group of people or one person. A second category may be a black and white multifunction printer and/or copier (B/W MFP). A third category may be for color printers, color multifunction printers and/or copiers (Color MFP). It is contemplated that the fleet of printers may be located on more than one customer network.

The third party hosting network 108 may also include one or more storage systems 122. The storage system 122 may host a web site, web application, web interface, database, and/or the like for some or all the techniques described herein for calculating a CPP.

The individual network 110 may include one or computers 124 that allow a user to input certain parameters into the computer 124. The computer 124 may then communicate with the computer 112, the storage system 114, the storage system 122, or any combination thereof. This allows the user to input parameters and receive a CPP remotely, based on the parameters. The individual network 110 may be, for example, a user's home network, cellular phone network (e.g., GSM, TDMA, CDMA, or the like), a WiFi hotspot, or any other network.

In another embodiment, an operator may use a computer to communicate with the computer 112 and/or storage systems 114, 122 over the network 106 (e.g., the Internet). The computer may provide a web interface that allows the operator to input certain parameters and generate a CPP over the network 106. The server may be located at the provider network 104 or at a third party network 108 or some combination of both. For example, the web interface may be hosted by a third party, such as storage system 122, but the server and/or database containing the software and/or hardware to calculate the CPPs may be located at the provider network 104. In this example, the operator uses computer 124 to input the parameters into a web interface over the WAN 106. The hosted web interface then communicates that information, e.g., to computer 112 and/or storage system 114 on the provider network 104 for calculating the CPPs. After the CPPs are calculated, the CPPs are transmitted to the third party network 108 and presented to the operator through the web interface. The CPPs are thus transformed into visual objects and observable on the operator's computer 124.

In another embodiment, the operator is on the customer network 102 using a computer 118 to obtain the CPPs over the WAN 106.

In another embodiment, an operator uses the computer 118 or storage system 120 to input some information regarding the customer's fleet of printers. The computer 118 or storage system 120 may then connect to another computer or storage system on a different network (e.g., provider network 104, third party network 108, individual network 110, etc.) that completes the processing of the information and calculations of one or more CPPs.

In yet another embodiment, an operator may be using a computer 126 or storage system 128 that is not connected to any network. In this embodiment, information may be inputted into the computer 126 and/or storage system 128 and all processing and calculations are performed locally on the computer 126 and/or storage system 128. The computer 126 and/or storage system 128 will then transform and output the resulting one or more CPPs to an external device.

In another embodiment, the system can operate in a hosted cloud or client/server architecture. The system can provide for the capability of incorporating the cost of multiple hardware and software products and/or technologies into the calculated cost-per-page. To support the needs of a dynamic and rapidly changing environment, the system may provide for real-time adaptive calculation of the cost-per-page based upon the receipt of data broadcast from a printing device to the system over a computer network. The real-time data and calculation can then be accessed by any computer device attached to the system network.

For example, the printers and/or copiers 116 may continuously or intermittently broadcast their current page counts as well as information about their hardware or parts to the other devices on the customer network 102 or to any network connected to the WAN 106 such as networks 104, 108, or 110. The computer 118 and/or storage system 120 may compile this information and also broadcast this information over the WAN 106 to any connected network. Any of the computers and/or storage systems 112, 114, 122, and/or 124 may receive the broadcasted information and perform one or more actions with the information. For example, the computers and/or storage systems 112, 114, 122, and/or 124 may store the information in a database so that one or more CPPs can be calculated based on the information in the database. As another example, one or more CPPs may be calculated or updated after receiving the broadcasted information. As yet another example, service to one or more of the printers and/or copiers 116 may be performed based the broadcasted information, e.g., indicating that a part is broken or a maintenance kit needs to installed.

Users or operators using one computer may communicate with any of the computers or devices on the customer network. Likewise, in one form, users or operators using one computer may communicate with any of the other computers or storage systems on the CPP provider network as well as the individual network and third party network. In other embodiments, access to computers or storage systems on the CPP provider network and/or the individual network and/or third party network may be limited and/or may be restricted to certain users or operators.

As part of determining a CPP, one piece of information that may be used to compute a CPP is the page count information from each printer that is to be covered by the CPP. The page count information may be retrieved from each printer manually by an operator. Or, software running on one or more devices, including but not limited to the computer 118 or storage system 120, may request the page count information for each printer 116 on the customer network 102. Once the page count information has been determined, it is forwarded for processing CPP. For example, an operator may enter that information into the storage system 124 or computer 118 on the CPP provider network 104. As another example, the page count information may be transmitted, e.g., by computer 118 or storage system 120 to, e.g., computer 112, storage system 114, and/or storage system 122, e.g., through the WAN 106.

The system 100 is illustrated as an exemplary schematic diagram of relationships. Particular embodiments of the system 100 may utilize various computers instead of or in addition to computers in other configurations, and data may be stored in various storage systems instead of or in addition to storage system and/or generated in real time during operations of the system 100. The computers may be any type of computer including but not limited to, a desktop computer, a laptop computer, a personal digital assistant (PDA), smart phone, cell phone, or tablet computer. The storage system may be any type of server or database management system and may also be a computer as described above.

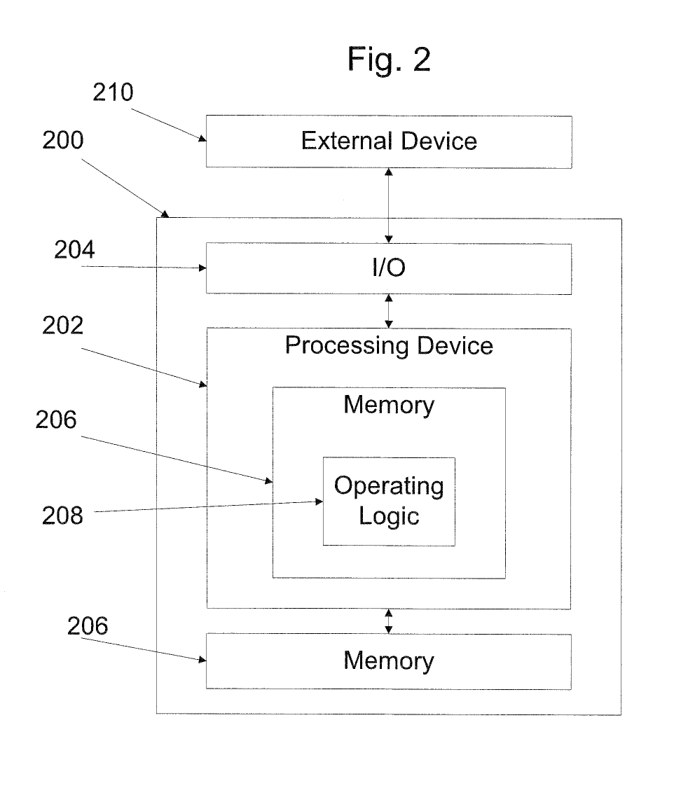

FIG. 2 is a schematic diagram of a computer 200. The computer 200 may be any of the computers 112, 118, 124, 126 shown in FIG. 1 as well as any of the storage systems 114, 120, 122, 128 shown in FIG. 1. Computer 200 includes a processing device 202, an input/output device 204, memory 206, and operating logic 208. Furthermore, computer 200 communicates with one or more external devices 210.

The input/output device 204 may be any type of device that allows the computer 200 to communicate with the external device 210. For example, the input/output device may be a network adapter, network card, or a port (e.g., a USB port, serial port, parallel port, VGA, DVI, HDMI, FireWire, CAT 5, or any other type of port). The input/output device 204 may be comprised of hardware, software, and/or firmware. It is contemplated that the input/output device 204 includes more than one of these adapters, cards, or ports.

The external device 210 may be any type of device that allows data to be inputted or outputted from the computer 200. For example, the external device 210 may be another computer, a server, a printer, a display, an alarm, an illuminated indicator, a keyboard, a mouse, or a touch screen display. Furthermore, it is contemplated that the external device 210 may be integrated into the computer 200. For example, the computer 200 may be a smartphone, a laptop computer, or a tablet computer in which case the display would be an external device 210, but the display is integrated with the computer 200 as one unit, which consistent with the general design of smartphones, laptop computers, tablet computers, and the like. It is further contemplated that there may be more than one external device in communication with the computer 200.

Processing device 202 can be of a programmable type, a dedicated, hardwired state machine, or a combination of these; and can further include multiple processors, Arithmetic-Logic Units (ALUs), Central Processing Units (CPUs), or the like. For forms of processing device 202 with multiple processing units, distributed, pipelined, and/or parallel processing can be utilized as appropriate. Processing device 202 may be dedicated to performance of just the operations described herein or may be utilized in one or more additional applications. In the depicted form, processing device 202 is of a programmable variety that executes algorithms and processes data in accordance with operating logic 208 as defined by programming instructions (such as software or firmware) stored in memory 206. Alternatively or additionally, operating logic 208 for processing device 202 is at least partially defined by hardwired logic or other hardware. Processing device 202 can be comprised of one or more components of any type suitable to process the signals received from input/output device 204 or elsewhere, and provide desired output signals. Such components may include digital circuitry, analog circuitry, or a combination of both.

Memory 206 may be of one or more types, such as a solid-state variety, electromagnetic variety, optical variety, or a combination of these forms. Furthermore, memory 206 can be volatile, nonvolatile, or a mixture of these types, and some or all of memory 206 can be of a portable variety, such as a disk, tape, memory stick, cartridge, or the like. In addition, memory 206 can store data that is manipulated by the operating logic 208 of processing device 202, such as data representative of signals received from and/or sent to input/output device 204 in addition to or in lieu of storing programming instructions defining operating logic 208, just to name one example. As shown in FIG. 2, memory 206 may be included with processing device 202 and/or coupled to the processing device 202.

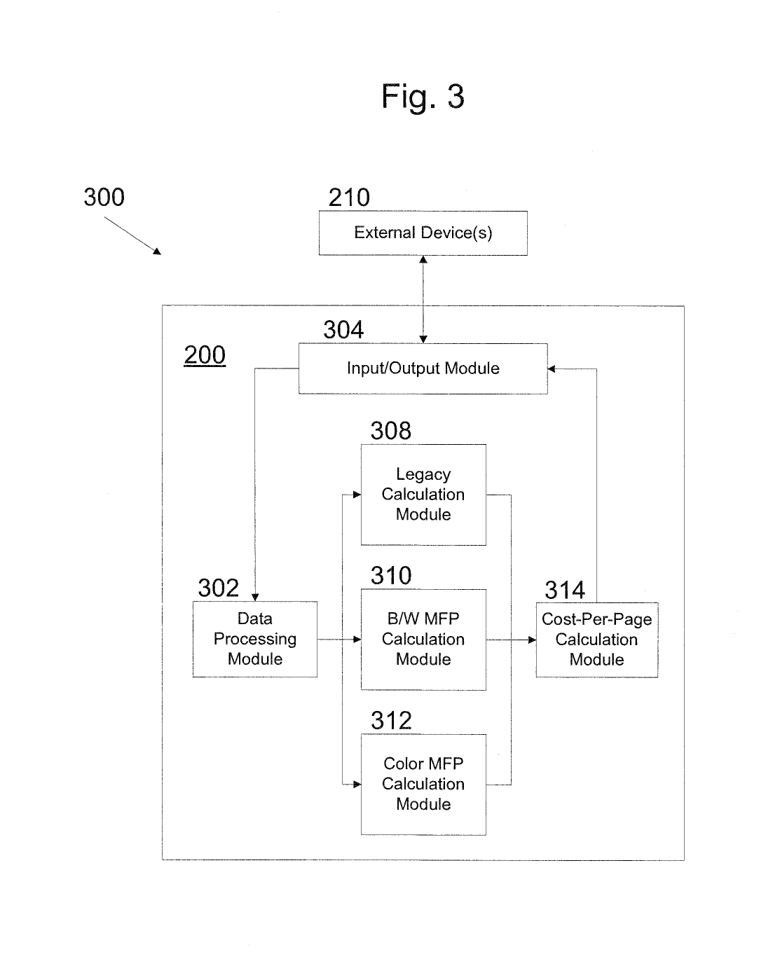

FIG. 3 is a schematic block diagram of a processing subsystem 300 for providing a CPP to a customer. The processing subsystem 300 includes a processing device 202 that may be part of a computer 200 (or a storage system or distributed computing device). The processing device 202 includes modules configured to provide multiple functionalities relating to providing the CPP as well as providing other functionalities. The exemplary embodiments described herein may include a number of modules providing a number of functionalities. A module may be implemented as operations by software, hardware, artificial intelligence, fuzzy logic, or any combination thereof, or at least partially performed by a user or operator. In certain embodiments, modules represent software elements as a computer program encoded on a computer readable medium, wherein a computer performs the described operations when executing the computer program. A module may be a single device, distributed across devices, and/or a module may be grouped in whole or in part with other modules or devices. The operations of any module may be performed wholly or partially in hardware/software or by other modules. The presented organization of the modules is exemplary only, and other organizations, configurations and arrangements are contemplated.

The computer 200 includes an input/output module 304 that receives information from an external device 210. The input/output module 304 passes the information to a data processing module 302. In one exemplary embodiment, the data processing module 302 distributes the information based on printer category (e.g., Legacy, B/W MFP, or Color MFP). For example, information about Legacy devices is transferred to the legacy calculation module 308. Information about B/W MFPs is sent to the B/W MFP calculation module 310. And, information about Color MFPs is sent to the Color MFP calculation module 312. It is contemplated that the printer information may be categorized differently as well as distributed to different modules.

Each of the modules performs calculations used to determine a CPP. After the modules have performed their calculations the information is then passed to the cost-per-page calculation module 314, which determines one or more CPPs. The cost-per-page calculation module 314 also processes any adjustments in the CPPs. The CPPs are then transferred to the input/output module 304, where the CPPs are processed, transformed, and outputted to the external device 210. In one embodiment, the external device 210 may be any type of device that allows an operator to visually observe the one or more CPPs. For example, the external device 210 may include, but is not limited to, a display or monitor, a computer with a display, a cell phone, a smart phone, a PDA, a terminal with a display connected to it, a printer, a server or distributed processing system or a laptop or desktop computer.

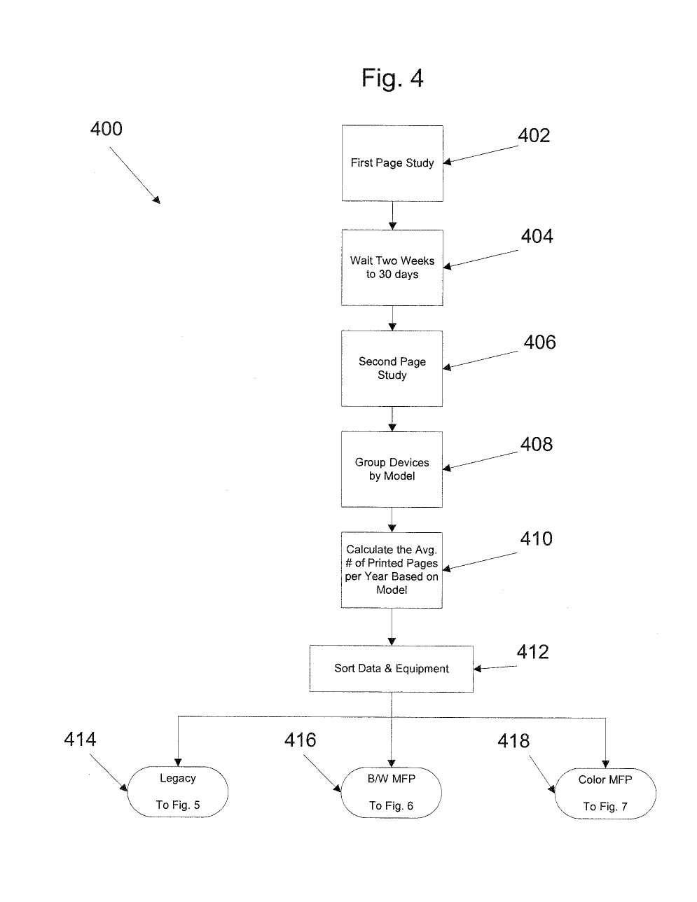

The schematic flow diagram in FIG. 4, and the related descriptions which follow, are illustrative embodiments of a technique for calculating a cost per page for a fleet of printing devices. Operations illustrated are understood to be exemplary only, and operations may be combined or divided, and added or removed, as well as re-ordered in whole or in part, unless explicitly stated to the contrary. The techniques 400, 500, 600, 700, 800, and 900, may be implemented by one or more computers executing one or more computer programs stored on a computer readable medium. The computer program comprises instructions or operating logic causing the computer to execute one or more of the operations of the techniques 400, 500, 600, 700, 800, and 900. In certain embodiments, the computer program may be comprised of modules, such as those described herein.

The technique 400 includes an operation 402 in which a first page study is conducted. During a page study, the total number of pages printed for each printer in a fleet of printers at a customer is collected. The collection of this information may occur in a variety of ways.

In one embodiment, an operator from a CPP provider may manually record all of the print totals for each printer in the fleet. In another embodiment, an operator may enter the information into an appropriate computer or storage system on the CPP provider network 104 or the third party network 108 through the WAN 106.

In another embodiment, a software program, such as FMAudit and Hewlett-Packard's Web Jetadmin or any other suitable program, collects the total number of pages printed by each printer. These programs may be executed on computer 118 or storage system 120 on the customer network 102 or may be executed on any computer or server on a different network 104, 108, 110 that communicates with the customer network 102 through a WAN 106 such as the Internet to collect the total number of pages printed.

Once this information has been collected about each printer in a fleet, the information may be entered into the computer 112 or storage system 114 in a variety of ways, e.g., as discussed above. In one embodiment, an operator manually inputs the data into the computer 112 through a keyboard connected to the computer 112.

In another embodiment, the information is transmitted from the customer network 102 to the computer 112 or storage system 114 on the CPP provider network 104. In this embodiment, the information may be stored on a computer 118 or storage system/server 120 on the customer network 102 until the appropriate time for transmitting the data to the CPP provider network 104. The information includes the number of pages each printer has printed at that time. Preferably, for Legacy printers and Color MFPs, the information includes a breakdown of black and white pages printed as well as color pages printed.

Next, operation 404 includes waiting for a period of time. In one form, the period of time is approximately two weeks to 30 days. In other embodiments, other suitable time periods may be employed. The time period is selected to be a sufficient amount of time to determine the average number of pages printed by a company or organization during normal use. For example, the two weeks to 30 days time period may allow any high volume print days to balance out with low volume print days. Extending beyond 30 days may be beneficial for further determining average printing during normal use.

Operation 406 includes a second page study. The second page study should generally be conducted in a similar manner as the first page study. The purpose of the second page study is to collect the total number of pages printed by each printer, e.g., in a fleet.

Operation 408 includes grouping the devices by model. As will be seen later, printing devices may be grouped by model because various components vary in price based on model.

In operation 410, the average number of pages printed, e.g., per year, based on the model is calculated. The total number pages printed for each group based on model in the first page study is subtracted from the total number of pages printed by each group based on model from the second page study. That number is then divided by the number of days between the first and second page studies. That result is then divided by the numbers of devices in that particular group. The resulting value is the average number of pages printed for device in one group per day. That number is then multiplied by, e.g., 365 to arrive at the average yearly number of pages printed by one device in one group.

In operation 412, the printing devices are generally sorted into three categories: Legacy, B/W MFP, and Color MFP. It is contemplated that other groupings or categorization of printers are possible and may implemented. Sorting is performed so that the CPP for each category can be calculated consistently for similar printers.

In operation 414, data for Legacy printers is transferred to the scheme 500. In operation 416, B/W MFP data is transferred to scheme 600. In operation 418, Color MFP data is transferred to scheme 700.

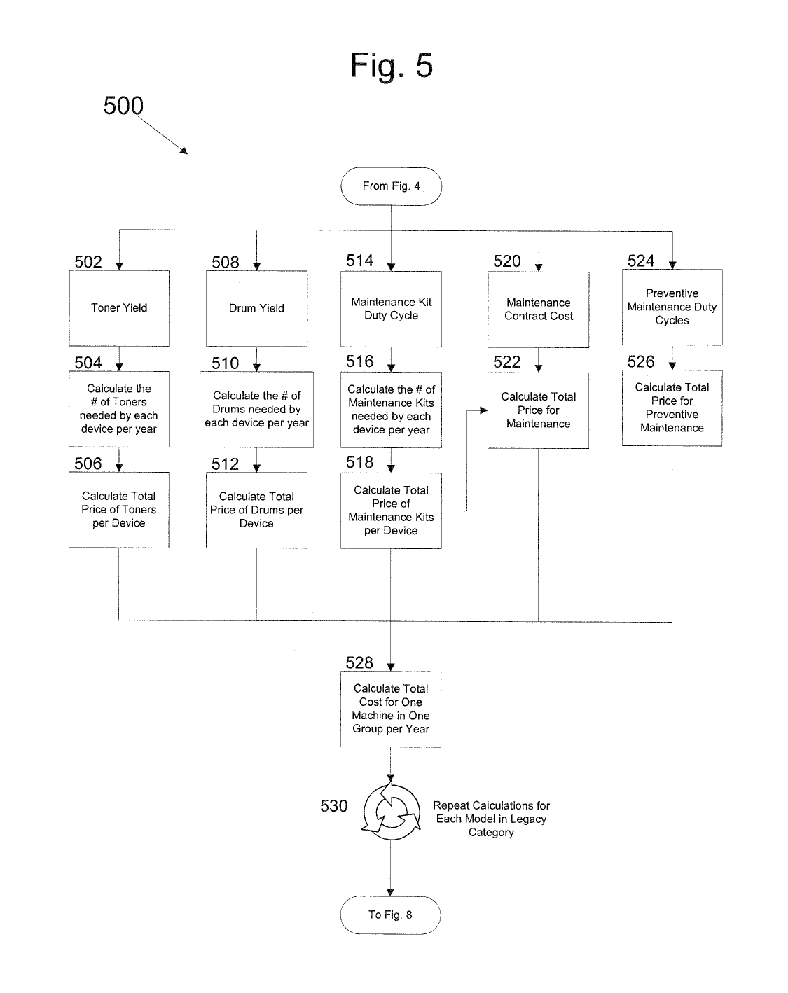

The schematic flow diagram in FIG. 5, and the related descriptions which follow, are illustrative embodiments of a technique for calculating the total yearly cost for one printing device in the Legacy category.

Operation 502 includes determining or calculating the toner yield. Each type of printing device is unique and uses a different quantity of toner. The toner yield may be inputted into the system based on information from the manufacturer of the toner or printer or based on experience. In addition the toner yield may be adjusted to compensate for inaccurate values being supplied by the manufacturer or based on experience with that particular toner. For example, the toner yield may be adjusted by 10%. In addition, an operator may select which type of toner is used such as original equipment manufacturer (“OEM”), Hewlett-Packard's SMP OEM (“SMP OEM”), remanufactured (“reman”), or MICR toners. SMP OEM is a special package and pricing for parts from Hewlett-Packard that they provide to certain partners. MICR is a type of toner that includes a magnetic material and is used for printing special items such as checks.

Operation 504 includes calculating the number of toners needed by each device per year. The number of toners needed by each device per year is calculated by dividing the average number of pages printed per year by one device by the toner yield. In operation 506, the total price of toners per device is calculated by multiplying the price of one toner by the number of toners needed. The price of toners may be adjusted as discussed later.

Operation 508 includes calculating the drum yield. Similar to calculating the toner yield in operation 502, the drum yield for each device may be inputted into the system based on information from a manufacturer, or may be based on historical data for that type of printing device. In addition, an operator may select which type of drum is used such as OEM, SMP OEM, or Reman.

Operation 510 includes calculating the number of drums needed by each printing device per year. The number of drums needed by each printing device per year is calculated by dividing the average pages printed per year by one device by the drum yield.

Operation 512 includes calculating the total price of drums per device. The total price of drums per device is calculating by multiplying the price of one drum by the number of drums needed per year. Similar to the toner calculations, if more than one color is present and more than one drum, the drum calculations are repeated for each color and drum.

In operation 514, the maintenance kit duty cycle is calculated. A maintenance kit duty cycle is generally described as the frequency at which maintenance kits should be applied to a given printer/copier unit, e.g., based on the number of pages printed. Information about the maintenance kit duty cycle may be provided by the manufacturer of the printer or may be based on historical information about that particular type of printer. The maintenance kit duty cycle value is then inputted into the system. In operation 516 the number of maintenance kits needed by each device per year is calculated by dividing the average number of pages printed by each device per year by the maintenance kit duty cycle. This result is then passed to operation 518 and operation 522. In operation 518 the total price of maintenance kits per device per year is calculated by multiplying the price of one maintenance kit by the number of maintenance kits needed per device per year. Typically, there are several maintenance kits with various duty cycles so these calculations are performed for each maintenance kit and duty cycle.

In operation 520, the maintenance contract cost is calculated. The contract cost may be calculated based on a CPP provider's contract price for labor, a particular labor burden rate, or a third party contract price for labor and maintenance, or any combination thereof. In operation 522 the total price for maintenance is calculated by adding the total price of maintenance kits per device from 518 and the maintenance contract cost from 520.

In addition, with respect to maintenance, third party maintenance options, such as HP Partner Delivered Care Packs, may be selected rather than a regular maintenance package. Other providers include Pitney Bowes for example.

In operation 524, preventative maintenance is calculated. Printing devices in the Legacy category are generally older than devices in the other two categories and thus require preventative maintenance to ensure a long working life. Preventative maintenance may include, but is not limited to, inspecting and cleaning rollers, the fusing assembly, paper trays, filters, transfer assembly, and/or toner cartridges. Pads and rollers may also be inspected and cleaned and/or replaced.

Next, in operation 526, the total price for preventative maintenance is calculated by adding together the price of each piece of preventative maintenance needed to maintain the working life of the printing device.

In operation 528, the total cost for one machine in one group per year is calculated. The total cost for one machine in one group per year is calculated by adding the results from operations, 506, 512, 518, 522, and 526. In particular, adding the total price of toners per device plus the total price of drums per device plus the total price for maintenance plus the total price of maintenance kits per device and plus the total price for preventative maintenance equals the total cost for one machine in one group per year.

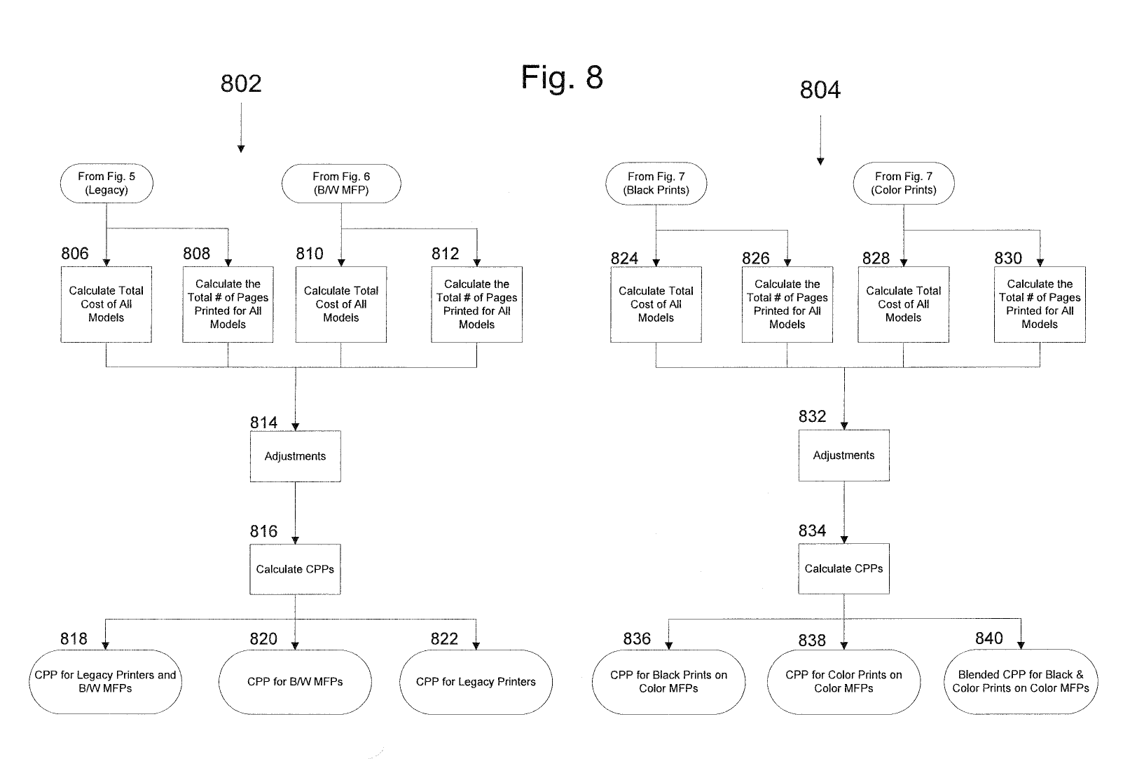

In operation 530, the total cost for one machine in group is calculated for every model group in the Legacy category. In other words these calculations are repeated for each model group. Then, the scheme proceeds to FIG. 8.

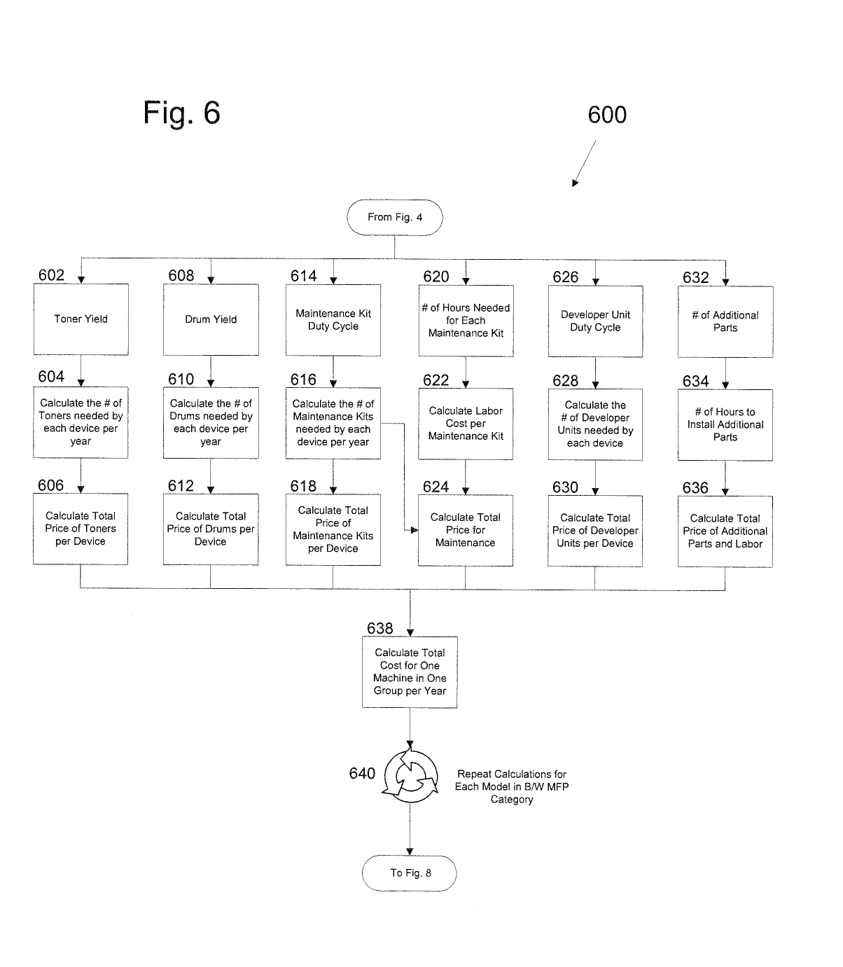

The schematic flow diagram in FIG. 6, in the related descriptions which follow, are illustrated embodiments of a technique for calculating the total yearly cost for one printing device in the B/W MFP category.

In operation 602, the toner yield is determined. The toner yield is different for each model of printer. The toner yield may be determined and inputted into the system based on information from the manufacturer or based on historical information for that particular model of printer. In addition, the toner yield may be adjusted by 10% or any other appropriate number. Furthermore, an operator may select which type of toner is used such as OEM, SMP OEM, Reman, or MICR toners. Next, in operation 604, the number of toners needed by each printing device per year is calculated by dividing the average number of pages printed per device by the toner yield. In operation 606, the total price of toners per device is calculated by multiplying the price of one toner by the number of toners needed. An operator may also adjust the pricing for the toners as discussed later.

In operation 608, the drum yield is determined. Similar to previous embodiments, the drum yield may be determined based on information from the manufacturer of the drums and/or printer, or may be determined based on historical information. Furthermore, an operator may select which type of drum is used such as OEM, SMP OEM, or Reman. In operation 610, the number of drums needed by each printing device per year is calculated by dividing the average number of pages printed per device per year by the drum yield. In operation 612, the total price of drums per printer is calculated by multiplying the price of one drum by the number of drums needed.

In operation 614, the maintenance kit duty cycle is determined. The duty cycle information may be inputted into the system based on information from the manufacturer or based on historical information. In operation 616, the number of maintenance kits needed by each device per year is calculated by dividing the average pages printed per device by the maintenance kit duty cycle. In operation 618, the total price of maintenance kit per device per year is calculated by multiplying the price of maintenance kits by the number of maintenance kits needed. Typically, there are several maintenance kits with various duty cycles so these calculations are performed for each maintenance kit and duty cycle.

Furthermore, it is contemplated that the maintenance kits in the B/W MFP category may also include preventative maintenance kits as well. The costs associated with preventative maintenance will be calculated, e.g., in a similar manner as described above with respect to the Legacy category.

In operation 620, the number of hours needed for installing each maintenance kit is determined. This information may be determined from the manufacturers of the maintenance kits or based on historical information regarding the length of time required to install a maintenance kit. Next, in operation 622, the labor cost per maintenance kit is calculated by multiplying the number of hours needed for each maintenance kit by the service burden rate. In operation 624, the total price for maintenance is calculated by multiplying the labor cost per maintenance kit by the number of maintenance kits needed per device.

In operation 626, the developer unit duty cycle is determined based on information from the manufacturer or based on historical information. Next, in operation 628, the number of developer units needed by each printing device per year is calculated by dividing the average number of pages printed per device by the developer unit duty cycle. In operation 630, the total price of developer units per printing device is calculated by multiplying the price of one developer unit by the number of developer units needed.

In operation 632, the number of additional parts needed by each device per year is determined generally based on information from the manufacturer or historical information for that model of printer. These parts are generally outside the scope of parts included in maintenance kits. Next, in operation 634, the number of hours needed to install the additional parts is determined based on information from the manufacturer or based on historical information for that particular model of printer. In operation 636, the total price for additional parts and labor is calculated by multiplying the labor burden rate by the total hours required for installation, which is then added to the price for each additional part.

In operation 638, the total cost for one machine in one group per year is calculated by adding the values from operations 606, 612, 618, 624, 630, and 636. In operation 640, the above calculations are repeated for each model in the B/W MFP category. After processing all the information for each model in the B/W MFP category, the scheme proceeds to the schematic flow diagram in FIG. 8.

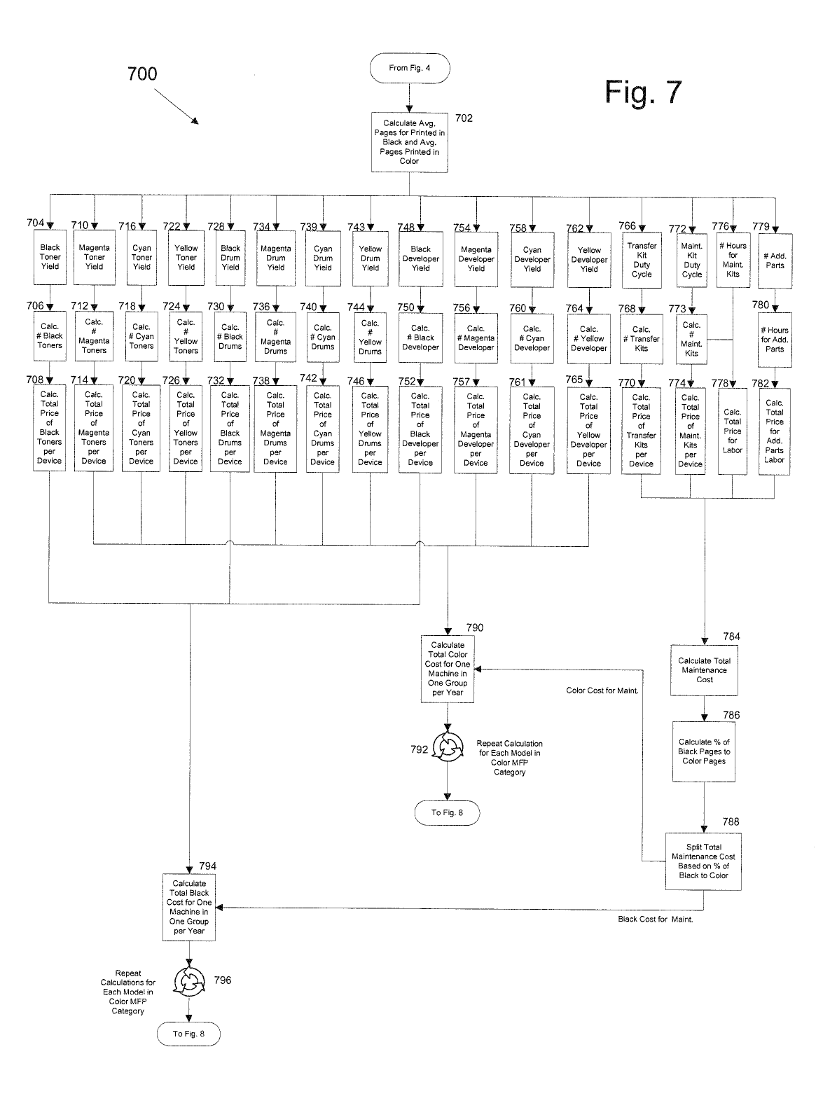

The schematic flow diagram in FIG. 7, and the related descriptions which follow, are illustrated embodiments of a technique for calculating the total yearly cost for one printing device in the Color MFP category.

In operation 702, the average number of pages printed in black and the average pages printed in color per year by one device are calculated. These averages are calculated, e.g., based on the page study information discussed earlier. For example, the number of black and white pages printed is calculated by dividing the total number of black and white pages printed for one model group by the number of printers of that model. Similarly, the average number of color pages printed is calculated by dividing the total number of color pages printed for a particular by the number of printers of that model. This information is used to assign the appropriate cost value for toner, drums, developer units, and transfer kits based on the percentage of black and white prints vs. color prints.

In operation 704, the black toner yield is determined, e.g., based on information from the manufacturer or based on historical information. Additionally, the toner yield may be adjusted by 10%. Furthermore, an operator may select which type of toner is used such as OEM, SMP OEM, or Reman toners. In operation 706, the number of black toners needed by each device per year is calculated by dividing the average number of black pages printed per year by the black toner yield. In operation 708, the total price of black toners per device is calculated by multiplying the price of each black toner by the number of black toners needed by each device.

In operation 710, the magenta toner yield is determined, e.g., based on historical information or based on information from the manufacturer. In addition, the toner yield may be adjusted by 10% or any other appropriate number. Furthermore, an operator may select which type of toner is used such as OEM, SMP OEM, or Reman toners. In operation 712, the number of magenta toners needed per year per device is calculated by dividing the average number of color pages printed per year by the magenta toner yield. In operation 714, the total price of magenta toners per device is calculated by multiplying the number of magenta toners needed per year by the price of a magenta toner.

In operation 716, the cyan toner yield is determined, e.g., based on information from the manufacturer or based on historical information. In addition, the toner yield may be adjusted by 10% or any other appropriate number. Furthermore, an operator may select which type of toner is used such as OEM, SMP OEM, or Reman toners. In operation 718, the number of cyan toners needed by each device per year is calculated by dividing the average number of color pages printed per year per device by the cyan toner yield. In operation 720, the total price of cyan toners is calculated by multiplying the price of a cyan toner by the number of cyan toners needed by each device per year.

In operation 722, the yellow toner yield is determined, e.g., based on information from the manufacturer or based on historical information. In addition, the toner yield may be adjusted by 10% or any other appropriate number. Furthermore, an operator may select which type of toner is used such as OEM, SMP OEM, or Reman toners. In operation 724, the number of yellow toners needed per year per device is calculated by dividing the average number of color pages printed by the yellow toner yield. In operation 726, the total price of yellow toners per device is calculated by multiplying the price of one yellow toner by the number of yellow toners needed by each device per year.

In operation 728, the black drum yield is determined, e.g., based on information from the manufacturer or based on historical information. Furthermore, an operator may select which type of drum is used such as OEM, SMP OEM, or Reman. In operation 730, the number of black drums needed by each device per year is calculated by dividing the average number of black pages printed by the black drum yield. In operation 732, the total price of black drums per device per year is calculated by multiplying the price of one black drum by the number of black drums needed per year.

In operation 734, the magenta drum yield is determined, e.g., based on information from the manufacturer or based on historical information. Furthermore, an operator may select which type of drum is used such as OEM, SMP OEM, or Reman. In operation 736, the number of magenta drums needed by each device per year is calculated by dividing the average number of color pages printed per year per device by the magenta drum yield. In operation 738, the total price of magenta drums per device per year is calculated by multiplying the price of one magenta drum by the number of magenta drums needed per year.

In operation 739, the cyan drum yield is determined, e.g., based on information from the manufacturer or based on historical information. Furthermore, an operator may select which type of drum is used such as OEM, SMP OEM, or Reman. In operation 740, the number of cyan drums needed by each device per year is calculated by dividing the average number of color pages printed per year per device by the cyan drum yield. In operation 742, the total price of cyan drums per device per year is calculated by multiplying the price of one cyan drum by the number of cyan drums needed per year.

In operation 743, the yellow drum yield is determined, e.g., based on information from the manufacturer or based on historical information. Furthermore, an operator may select which type of drum is used such as OEM, SMP OEM, or Reman. In operation 744, the number of yellow drums needed by each device per year is calculated by dividing the average number of color pages printed by each device per year by the yellow drum yield. In operation 746, the total price of yellow drums per device per year is calculated by multiplying the price of one yellow drum by the number of yellow drums needed per year.

In operation 748, the black developer yield is determined, e.g., based on information from the manufacturer or based on historical information. In operation 750, the number of black developer units needed by each device per year is calculated by dividing the average number of black pages printed per year by the black developer yield. In operation 752, the total price of black developer per device per year is calculated by multiplying the cost of one black developer unit by the number of black developer units needed per year.

In operation 754, the magenta developer yield is determined, e.g., based on information from the manufacturer or based on historical information. In operation 756, the number of magenta developer units needed by each device per year is calculated by dividing the average number of color pages printed per year by the magenta developer yield. In operation 757, the total price of magenta developer units per device is calculated by multiplying the price of one magenta developer unit by the number of magenta developer units needed per year.

In operation 758, the cyan developer yield is determined, e.g., based on information from the manufacturer or based on historical information. In operation 760, the number of cyan developer units needed by each device per year is calculated by dividing the average number of color pages printed per year by the cyan developer yield. In operation 761, the total price of cyan developer units per device is calculated by multiplying the price of one cyan developer unit by the number of cyan developer units needed per year.

In operation 762, the yellow developer yield is determined, e.g., based on information from the manufacturer or based on historical information. In operation 764, the number of yellow developer units needed by each device per year is calculated by dividing the average number of color pages printed per year by the yellow developer yield. In operation 765, the total price of yellow developer units per device is calculated by multiplying the cost of one yellow developer by the number of yellow developer units needed per year.

Although this embodiment shows a developer unit for each color, it is contemplated that some printing devices only use one developer unit. Furthermore, if a printing device only uses one developer unit, then only one calculation for the cost of the developer needs to be performed rather than four as shown in FIG. 7.

In operation 766, the transfer kit duty cycle is determined, e.g., based on information from the manufacturer or based on historical information for that particular model of printing device. In operation 768, the number of transfer kits needed by each device per year is calculated by dividing the average number of black and color pages printed per year by the transfer kit duty cycle. In operation 770, the total price of transfer kits per year per device is calculated by multiplying the cost of one transfer kit by the number of transfer kits needed per year.

In operation 772, the maintenance kit duty cycle is determined, e.g., based on information from the manufacturer or based on historical information. In operation 773, the number of maintenance kits needed per year is calculated by dividing the average number of black and color pages printed per year by each device by the maintenance kit duty cycle. In operation 774, the total price of maintenance kits per device is calculated by multiplying the cost of one maintenance kit by the number of maintenance kits required per year by each device. Typically, there are several maintenance kits with various duty cycles so these calculations are performed for each maintenance kit and duty cycle.

Furthermore, it is contemplated that the maintenance kits in the Color MFP category may also include preventative maintenance kits as well. The costs associated with preventative maintenance will be calculated in a similar manner as described above with respect to the Legacy category.

In operation 776, the number of hours required for installing the maintenance kits is determined, e.g., based on information from the manufacturer or based on historical information. In operation 778, the total price for labor is calculated by multiplying the number of hours required for installing one maintenance kit by the number of maintenance kits required per device per year multiplied by the labor burden rate.

In operation 779, the number of additional parts is determined, e.g., based on information from the manufacturer or based on historical information. These parts are generally outside the scope of parts included in maintenance kits. In operation 780, the number of hours required for installing each of the additional parts is determined based on information from the manufacturer or based on historical information. In operation 782, the total price for additional parts and labor is calculated by multiplying the numbers of hours required for installing each part by the labor burden rate and then adding the cost of each additional part.

In operation 784, the total maintenance cost is calculated by adding the values from operations 770, 774, 778, and 782. In operation 786, the percentage or ratio of black pages printed to color pages printed is calculated based on the page study information. In operation 788, the total cost of maintenance is split based on the percentage of black pages printed to color pages printed. The cost of maintenance for black pages is calculated by multiplying the total maintenance cost times the percentage of black pages printed. Likewise, the cost for color pages printed for maintenance is calculated by multiplying the total cost for maintenance by the percentage of color pages printed. By distributing the maintenance cost based on the type of pages printed, the CPPs will more accurately reflect the cost of printing either black and white pages or color pages because the corresponding percentage of the maintenance cost associated with printing that type of page will be incorporated into the appropriate CPP.

In operation 790, the total color cost for one machine in one group per year is calculated by adding the values from operations 714, 720, 726, 738, 742, 746, 757, 761, 765, and 788. In operation 792, the above calculations are repeated for each model in the Color MFP category.

In operation 794, the total cost for black pages printed for one machine and one group for year is calculated by adding the values from operations 708, 732, 752, and 788. In operation 796, these calculations are repeated for each model in the Color MFP category.

The schematic flow diagram in FIG. 8, and the related descriptions which follow, are illustrated embodiments of a technique for calculating various CPPs. The scheme 802 relates to calculating CPPs for pages printed using only black toner. The scheme 804 relates to calculating CPPs for black prints and color prints using a Color MFP.

In operation 806, the total cost of all model groups in the Legacy category is calculated by multiplying the cost of one model by the number of models in the group and repeating that calculation for each model group in the Legacy category and adding all of those values together. In operation 808, the total number of pages printed for all model groups in the Legacy category is calculated by adding together the page count information for the Legacy category from the page studies discussed earlier.

In operation 810, the total cost of all models in the B/W MFP category is calculated by multiplying the cost of one model by the number of models in the group and repeating that calculation for each model group in the B/W MFP category and adding all of those values together. In operation 812, the total number of pages printed for all models groups in the B/W MFP category is calculated by adding all of the page count information for the B/W MFP category from the page studies discussed earlier.

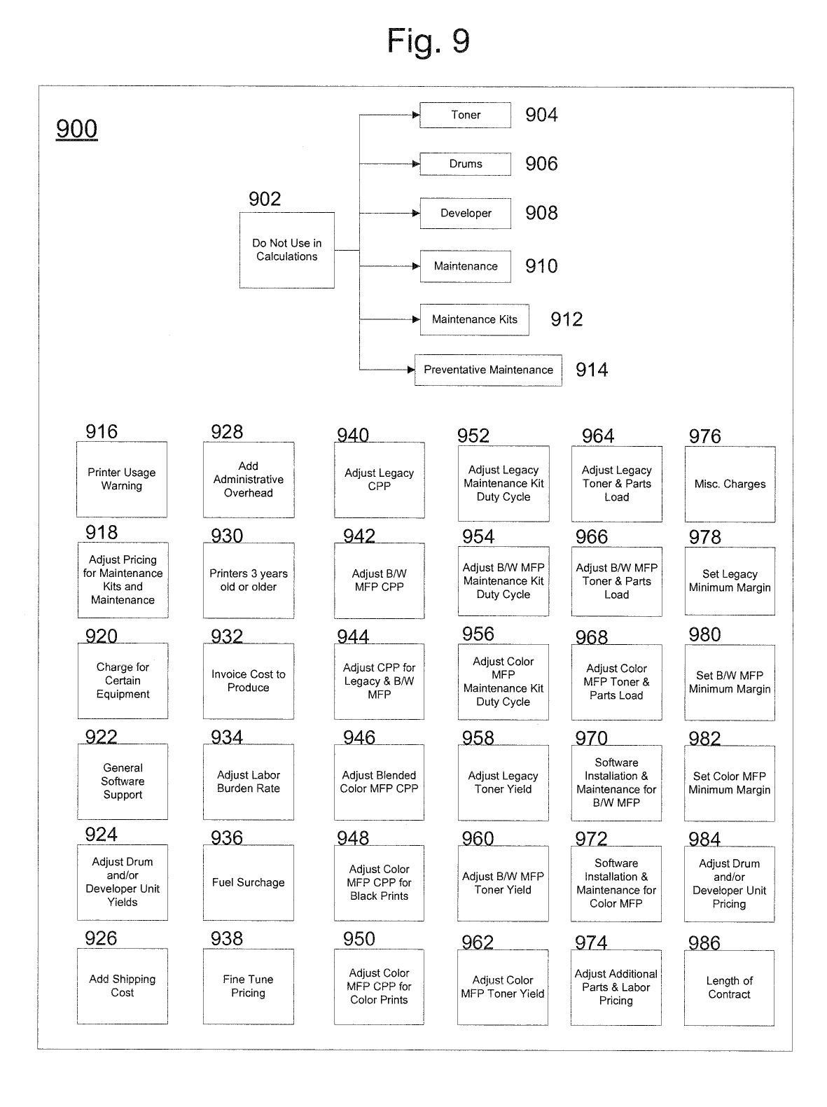

In operation 814, certain adjustments may be made to the calculations as shown in FIG. 9. In operation 816, the various CPPs are calculated by dividing the total cost by the number of pages printed. For example, a combined CPP 818 for Legacy printers and B/W MFPs may be calculated by adding the total cost of Legacy and B/W MFPs per year and dividing by the total number of pages printed per year by all devices in both categories. In another example, a combined CPP 818 may be calculated by multiplying the total cost of Legacy printers by the total number of pages printed by Legacy printers and adding to it the result of multiplying the total cost of B/W MFPs by the total number of pages printed by B/W MFPs. The result of that addition is then divided by the result of adding the square of the total number of Legacy pages printed and square of the total number of B/W MFP pages printed. In yet another a CPP 818 may be calculated by weighting the costs for Legacy and B/W MFP devices using the ratio of Legacy pages printed and B/W MFP pages printed. A CPP 820 for B/W MFPs is calculated by dividing the total cost of B/W MFPs per year by the total number of pages printed per year by devices in the B/W MFP category. A CPP 822 for Legacy printers is calculated by dividing the total cost of Legacy printers per year by the total number of pages printed by devices in the Legacy category.

In operation 824, the total cost of all models for black prints in the Color MFP category is calculated by multiplying the cost of black prints on one device per model group by the number of printers in that model group and repeating that calculation for each model group in the Color MFP and adding all those values together. In operation 826, the total number of black pages printed for all model groups is calculated by adding together the page count information from the page studies for Color MFP. In operation 828, the total cost of all model groups for color prints is calculated by multiplying the color cost of one device per year by the number of printers in that group and repeating that calculation for each different model group and adding all of them together. In operation 830, the total number of color pages printed for all model groups is calculated by adding together the page count information in the Color MFP category from the page studies discussed earlier.

In operation 832, adjustments as shown in FIG. 9 may be made to the CPP. In operation 834, the previously calculated values and adjustments are used to calculate CPPs. For example, a CPP 836 for black prints on Color MFP is calculated by dividing the total cost of black prints on Color MFPs by the total number of black pages printed on Color MFPs. A CPP 838 for color prints on Color MFPs is calculated by dividing the total cost of color prints on Color MFPs by the total number of color pages printed by devices in the Color MFP category. A blended CPP 840 for black and color prints on Color MFP/Copiers is calculated by adding the total cost of black and color prints on Color MFPs and dividing that summation by the total number of pages printed on Color MFPs. In another embodiment, the blended CPP 840 may also be calculated by averaging the two CPPs 836 and 838. In another embodiment, the blended CPP 840 is calculated by using the ratio of black pages printed to color pages printed to combine the two CPPs 836 and 838 proportionally. For example, a blended CPP 840 may be calculated by multiplying the total cost of black prints on Color MFPs by the total number of black pages printed by Color MFPs and adding to it the result of multiplying the total cost of color pages printed on Color MFPs by the total number of color pages printed by Color MFPs. The result of that addition is then divided by the result of adding the square of the total number of black pages printed on Color MFPs and square the total number of color pages printed on Color MFPs. Furthermore, it is contemplated that the blended CPP 840 may be calculated in other ways such as taking into account the ratio of black pages printed to color pages printed or take into account any other factors to calculate the blended CPP 840.

It is further contemplated that another CPP (not shown) may be calculated that represents the cost-per-page for all black pages print across all three categories. This CPP may be calculated by adding the total cost of black pages printed from the Legacy, B/W MFP, and Color MFP and dividing by the total number of black pages printed on Legacy, B/W MFPs, and Color MFPs.

Furthermore, other CPPs, or variations of the above CPPs, are contemplated. For example, more than one CPP for the Legacy category may be calculated that takes into account color pages and color parts similar to the calculations for the Color MFP if the Legacy printing device prints in color.

FIG. 9 shows an adjustments module 900 that includes a number of adjustments that may be made to change the various CPPs. One adjustment is 902 in which certain factors or elements are not used in the calculations. For example, the cost for toner 904, drums 906, developer units 908, maintenance 910, maintenance kits 912, and preventative maintenance 914 may be excluded from the CPP calculations. There may be a variety of reasons why a CPP provider would wish to exclude one or more of these factors. For example, a third party or the customer may be providing one or more of these elements, such as toner or drums or developer units, and thus, such elements do not need to be provided by the CPP provider and should be removed from CPP calculations.

Another adjustment is the printer usage warning adjustment 916. Printer manufacturers generally provide information on the suggested maximum number of pages a printer should print per month or per year so as not to damage the printing device. This information may be used by the present system to provide a warning to an operator if the customer is planning on overusing one of their printers beyond the manufacturer's suggested maximum printing capacity. If so, the printer usage warning will provide a notification to the operator in the form of a visual notification on a computer screen for example, or on a printed piece of paper, or an alarm. If a customer is going to exceed the manufacturer's suggested maximum printing capacity, the customer should purchase a new printing device that is capable of handling all of the customer's capacity. Or, a customer may redesign or redistribute printing devices to ensure proper capacity. Otherwise, the printing device will fail earlier and require more maintenance than is normally required, which will make the CPP calculation imprecise.

Another adjustment 918 is for adjusting pricing for maintenance kits. The price of a maintenance kit may be inputted into the system by an operator. Or, the operator may adjust the price for maintenance kits by entering a percentage to either increase or decrease the cost. The price for third party maintenance, which includes the maintenance kit and labor, may be entered as a CPP value or as a price number that may be incorporated into the CPPs calculated by the present application. This situation may occur when a third party is providing the maintenance for a particular printing device. This adjustment 918 may also be used to adjust the value of the maintenance kit including maintenance or labor.

Adjustment 920 is for charging for certain equipment. The cost of the equipment will be incorporated into the calculated CPPs. For example, a customer may choose to purchase five additional printers. The cost of those five printers may be added into the CPP calculation rather than billing the customer for the printers independently.

The adjustment 922 for general software support will also be included into the CPP. This software may include various functionalities such as scan to email. In addition, this software may be used for supporting and monitoring the fleet of printers at a customer's location. The adjustment may be entered as a CPP value or a percentage.

Another adjustment 924 is for adjusting the drum and/or developer unit yields. Some drums or developer units may not achieve the number of printed pages or yields as stated by the manufacturer. It may be beneficial to adjust the drum and/or developer yield by a certain percentage such as 10% to account for the loss. For color devices, each drum or developer unit for each color may be adjusted independently.

Another adjustment 926 allows additional shipping costs to be added into the CPP calculation. This shipping cost may be for example, the cost of shipping toners, drums, developer units, and the like to the customer. The shipping cost may be added as a percentage of the value of the item being shipped. Moreover, this may be convenient for the customer because the cost is part of the CPP and not an independent charge.

The adjustment 928 is for adding administrative overhead costs to the CPPs. Administrative overhead may include, for example, the costs associated with servicing a large or small client or a client that requires more frequent billing that would drive up the administrative costs for the CPP provider. Administrative overhead may also include recovering costs for preparing and processing contracts. This adjustment allows the CPP provider to pass that cost on to the customer through the CPP.

The adjustment 930 requires that for printers that are three years old or older, the operator must input the starting page count. The operator must put in the starting page count for these older printers because the older printers will be closer to a point in the duty cycle where, for example, a transfer kit or a maintenance kit is required. In this way, a maintenance kit or transfer kit for an older printer that is required within the first few months or first year or even first two years, will be reflected in the CPP as opposed to a brand new device, in which the kit may not be required until after the expiration of the contract.

The adjustment 932 is for invoicing the cost to produce. This allows the CPP provider to pass the invoice cost and other associated costs to produce on to the customer.

The adjustment 934 is for adjusting the labor burden rate. This adjustment allows the CPP provider to either increase or decrease their hourly labor rate as a percentage or as a whole number (i.e., inputting the labor burden rate). The adjusted labor rate is then passed on to the customer through the CPPs.

The adjustment 936 is for adding a fuel surcharge to the CPPs. The fuel surcharge adjustment 936 is for situations where shipping and service travel costs do not adequately cover the cost of servicing the client or providing the replacement parts to the client. For example, during certain economic periods, e.g., when the price for oil is higher, shipping costs are generally higher as well.

The fine tuned pricing adjustment 938 is for adjusting the price of a particular model within a category. There may be instances where a CPP provider wishes to either increase or decrease the cost of a particular type of printer model and the adjustment 938 allows a CPP provider to pass that cost on to the customer through a CPP. The CPP may be adjusted as a percentage or by entering a value to add to the CPP.

The adjustment 940 is for adjusting the Legacy CPP. The adjustment 940 allows the CPP provider to increase or decrease the overall legacy CPP. The CPP may be increased or decreased as a percentage or by adding or subtracting a value to the CPP.

Similarly, the adjustment 942 allows a CPP provider to adjust the B/W MFP's CPP. The CPP may be increased or decreased as a percentage or by adding or subtracting a value to the CPP.

The adjustment 944 is for adjusting the CPP for the Legacy and B/W MFP's CPP. The CPP may be increased or decreased as a percentage or by adding or subtracting a value to the CPP.

The adjustment 946 is for adjusting the blended Color MFP's CPP. The CPP may be increased or decreased as a percentage or by adding or subtracting a value to the CPP.

The adjustment 948 is for adjusting the Color MFP's CPP for black prints. The CPP may be increased or decreased as a percentage or by adding or subtracting a value.

The adjustment 950 is for adjusting the Color MFP's CPP for color prints. The CPP may be increased or decreased as a percentage or by adding or subtracting a value.

The adjustment 952 is for adjusting the Legacy maintenance kit duty cycle. The CPP provider may wish to adjust the legacy maintenance kit duty cycle to reflect historical data that certain types of printers require their maintenance kits sooner or later than as required by the manufacturer.

The adjustment 954 is for adjusting the B/W MFP maintenance kit duty cycle. The CPP provider may wish to adjust the maintenance kit duty cycle to reflect historical data that certain types of printers require their maintenance kits sooner or later than as required by the manufacturer.

The adjustment 956 is for adjusting the Color MFP maintenance kit duty cycle. The CPP provider may wish to adjust the maintenance kit duty cycle to reflect historical data that certain types of printers require their maintenance kits sooner or later than as required by the manufacturer.

The adjustment 958 is for adjusting the Legacy toner yield. The adjustment 960 is for adjusting the B/W MFP toner yield. The adjustment 962 is for adjusting the Color MFP toner yield. For printing devices with more than one color, the yields for the different toners may be adjusted independently. The CPP provider may wish to adjust these yields to reflect historical data that certain types of printers require new toners sooner or later than as required by the manufacturer.

The adjustment 964 is for adjusting the Legacy toner and parts. The adjustment 966 is for adjusting the B/W MFP toner and parts. The adjustment 968 is for adjusting the Color MFP toner and parts. These adjustments allow a CPP provider to either adjust the cost of the toner and parts as a percentage or enter a specific value for the toner and parts. This is situation may arise if a third party is providing toner or certain parts. The third party contract price may be incorporated into the CPP.

The adjustment 970 is for adding the cost for software installation and maintenance for a B/W MFP. Similarly, the adjustment 972 is for software installation and maintenance for a Color MFP. For example, a CPP provider may install a program such as FMAudit or Web Jetadmin and maintain that program for the customer. This is a way for the CPP provider to charge the customer for that software and maintenance. The software and maintenance costs will be included into the CPPs.

The adjustment 974 is for adjusting the price of additional parts and labor in the B/W MFP category as seen in FIG. 6 and the Color MFP category as seen in FIG. 7. This allows the CPP provider to input a particular price for the parts and/or the labor burden rate. This is situation may arise if a third party is providing additional parts and labor. The third party contract price may be incorporated into the CPP.

The adjustment 976 is for adjusting or adding additional miscellaneous charges and passing those costs on to the customer through the CPPs.

The adjustment 978 allows an operator to set the minimum margin for the Legacy category. For example, a CPP provider may wish to make a 40% profit for servicing a fleet of printers in the Legacy category. The adjustment 978 allows an operator to input a minimum margin such as 40% into the CPP calculation. Similarly, the adjustment 980 allows an operator to set a B/W MFP minimum margin. The adjustment 982 allows an operator to set the Color MFP minimum margin.

The adjustment 984 is for adjusting the drum and/or developer unit pricing. The adjustment 984 allows an operator to insert a specific price or adjust the price as a percentage for the drums and/or developer units. For printing devices with more than one color and have more than one drum or developer unit, the pricing may be adjusted for each drum and/or developer unit. This pricing information will then be used in calculating the CPPs. This is situation may arise if a third party is providing drums or developer units. The third party contract price may be incorporated into the CPP.

The adjustment 986 allows an operator to input the length of the contract. The length of the contract may be relevant because the duty cycles for certain maintenance and transfer kits and additional parts will fall in different years so the CPP provider will generally wish to know when those events will occur so that the CPP reflects those maintenance kits and/or additional parts.

Based on the various CPP calculations, a variety of actions may be taken. For example, the CPP analysis may show that a customer's current printer fleet is inefficient for handling the volume of printing required by the customer. Therefore, the printer fleet at the customer's site(s) may be redesigned based on the various CPPs. For example, one or more multifunction printers may be added to compensate for large volume of printing. In another embodiment, some older printers may be sold and replaced by one or more larger-capacity new machines or smaller-capacity machines depending on printing volume. In yet another embodiment, printers may be relocated to other areas within the company so that the volume of printing is reduced on inadequate machines and other higher volume printers will take their place. In another embodiment, printing to certain machines may be restricted or encouraged based the cost of printing to devices in that model group or category.

In another example, an action that may be taken based on the CPPs is adjusting when paper, parts (e.g., toners, drums, kits, etc.), and servicing are scheduled at a customer location.

The present application may be implemented on any type of computer and using a variety of different software. For example, the present application may be implemented using Microsoft Excel, Microsoft Access, Microsoft SQL Server, any of Oracle's database systems, MySQL, custom software modules, custom databases, any other appropriate software or database, or any combination thereof. When the computer or storage system is configured as a database, it is contemplated that the database may be any type of database, such as relational, hierarchical, object-oriented, and/or the like.

A computer readable medium may refer to any tangible storage and/or transmission medium that participate in providing instructions to a processing device for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium.

While the invention has been described in connection with what is presently considered to be the most practical and preferred embodiment, it is to be understood that the invention is not to be limited to the disclosed embodiment(s), but on the contrary, is intended to cover various modifications and equivalent arrangements included within the spirit and scope of the appended claims, which scope is to be accorded the broadest interpretation so as to encompass all such modifications and equivalent structures as permitted under the law. Furthermore it should be understood that while the use of the word preferable, preferably, or preferred in the description above indicates that feature so described may be more desirable, it nonetheless may not be necessary and any embodiment lacking the same may be contemplated as within the scope of the invention, that scope being defined by the claims that follow. In reading the claims it is intended that when words such as “a,” “an,” “at least one” and “at least a portion” are used, there is no intention to limit the claim to only one item unless specifically stated to the contrary in the claim. Further, when the language “at least a portion” and/or “a portion” is used the item may include a portion and/or the entire item unless specifically stated to the contrary.

What is claimed is:

1. An apparatus, comprising:
a computer including a calculation module, wherein the calculation module is operable to calculate at least one cost-per-page for a fleet of printing devices;
the computer further comprising an adjustment module having one or more adjustments, wherein the adjustment module is structured to allow a user to select one or more of the adjustments to adjust the cost-per-page; and
an external device in communication with the computer, wherein the external device is structured to output the cost-per-page.

2. The apparatus of claim 1, wherein the calculation module is structured to calculate the cost-per-page using a ratio of black-and-white pages printed to color pages printed.

3. The apparatus of claim 1, wherein the calculation module is structured to calculate the cost-per-page by incorporating a cost of additional parts and labor.

4. The apparatus of claim 1, wherein the calculation module is structured to calculate the cost-per-page using a third party price for parts and labor; and
wherein the calculation module is structured to calculate the cost-per-page using at least one selected type of toner, drum, or developer unit.

5. The apparatus of claim 1, wherein the cost-per-page is calculated by apportioning costs based on color pages printed and black-and-white pages printed.

6. The apparatus of claim 1, wherein the computer calculates a first cost-per-page and a second cost-per-page.

7. The apparatus of claim 6, wherein the first cost-per-page is based on black-and-white printing devices and the second cost-per-page is based on color printing devices.

8. The apparatus of claim 1, wherein the calculation module is structured to use information about the fleet of printing devices to calculate the cost-per-page and wherein the information is categorized based on a type of printing device.

9. The apparatus of claim 1, wherein the cost-per-page includes a minimum margin.

10. A system, comprising:
a first computer structured to communicate with a second computer over a network;
wherein the first computer is structured to transmit information about a fleet of printers to the second computer over the network; and
wherein the second computer includes memory for storing the information and a processing device is structured to process the information and calculate a cost-per-page for the fleet of printers, and wherein the processing device is operable to incorporate one or more adjustments into the cost-per-page.

11. The system of claim 10, wherein the second computer is structured to transmit the cost-per-page to the first computer, and wherein the first computer includes display means for displaying the cost-per-page.

12. The system of claim 10, wherein the first computer communicates with the second device through a web interface over the network.

13. The system of claim 10, wherein the first computer is structured to receive at least part of the information from a third computer at a customer site.

14. The system of claim 10, wherein the cost-per-page is calculated by apportioning costs based on color pages printed and black-and-white pages printed.

15. The system of claim 10, wherein the first computer communicates with the second computer through a web application over the Internet.

16. A computer-implemented method for calculating a cost-per-page with a computer having a processing device, the method comprising:
receiving, with the computer, information about a fleet of printers;
calculating, with the processing device, a cost-per-page for the fleet of printers, wherein the processing device adjusts the cost-per-page based on a selected one or more adjustments; and
displaying the cost-per-page on an external device.

17. The method of claim 16, further comprising:
recommending a redesign of the fleet of printers based on the cost-per-page.

18. The method of claim 16, further comprising:
presenting the one or more adjustments on a display means for a user to select one or more of the adjustments.

19. The method of claim 16, further comprising:
sorting the information into more than one category based on printer type.

20. The method of claim 16, further comprising:
ordering a printer based on the cost-per-page.

21. The method of claim 16, further comprising:
changing a printer configuration based on the cost-per-page.

22. The method of claim 16, further comprising:
calculating, with the processing device, at least two cost-per-pages, wherein one cost-per-page is based on black-and-white pages printed and another cost-per-page is based on color pages printed.

23. A computer program product, comprising: a computer readable medium having computer readable program, wherein the computer readable program when executed on a computer causes the computer to: receive information about one or more printing devices, calculate a cost-per-page for the one or more printing devices using the information, and adjust the cost-per-page based on a selected one or more adjustments.

24. The computer program product of claim 23, wherein the computer readable program when executed on the computer further causes the computer to:
transmit the cost-per-page to another computer over a network.

25. The computer program product of claim 23, wherein the computer readable program when executed on the computer further causes the computer to:
apportion and incorporate information about black-and-white pages printed and color pages printed into the cost-per-page.

26. The computer program product of claim 23, wherein the computer readable program when executed on the computer further causes the computer to:
output the cost-per-page on a display.
